(19) United States
(12) Patent Application Publication
(10) Pub. No.: US 2024/0418038 A1
(43) Pub. Date: Dec. 19, 2024

(54) DOCK DOOR SCREEN ASSEMBLY AND METHOD OF USE THEREOF

(71) Applicant: ULTRA-LITE OVERHEAD DOORS LTD., Calgary (CA)

(72) Inventors: Darryl DYE, Calgary (CA); Christopher NESBITT, Calgary (CA)

(21) Appl. No.: 18/374,185

(22) Filed: Sep. 28, 2023

Related U.S. Application Data
(60) Provisional application No. 63/521,426, filed on Jun. 16, 2023.

(51) Int. Cl. E06B 9/54; E06B 9/58; E06B 9/72

(52) U.S. Cl. CPC E06B 9/54; E06B 9/581; E06B 9/72; E06B 2009/6809

(57) ABSTRACT

A dock screen system for covering an outside face of a dock doorway opening is described. The dock screen includes a frame sized to fit around the outside face of the dock doorway and affixed to the doorway; a guide rail mounted recessed in the frame; a screen track held in the guide rail; and a screen, extendably and retractably mounted on a mounting roll to move along the screen track. In an extended position, the screen sits directly against the outside face of the doorway and eliminates any gaps through which insects or debris could enter.

### FIELD

The present disclosure relates to screen doors for use with doorways of loading docks and methods of using the same.

### BACKGROUND

Loading docks are typically framed by a doorway for engagement by a vehicle for either loading or unloading of goods between the dock and the vehicle. The doorway is commonly provided with a dock door and dock seal for sealing the doorway opening for protection against the elements, security and to present access to inside of the loading dock.

At times it is desirable to have the dock door open even when loading or unloading is not taking place, for example to allow fresh air into a loading dock, to aid in temperature regulation or to increase ambient light. In such circumstances, it is also desirable to prevent ingress of dust, debris, insects, or small animals. In such cases a dock screen door can be used in addition to or in concert with the dock door.

Currently, dock screens are fitted inside the loading building in some type of relationship to a dock door, which is typically designed as a garage door, raisable with a motor along a track. In such cases, the screen is mounted on its own track either between the doorway and the dock door, or beyond the dock door, further inside the building. In both cases, the need for spacing and accommodating two tracks within the building means that the track furthest from the doorway (further inside the building) is not flush with the doorway. This leads to a gap all around either the dock door or the screen, whichever is further inside, then they are closed.

The other option used in the current state of the art is to mount the screen system into the doorjamb of the dock doorway. While this system may seal better with the doorway, the parts are all located in the doorjamb of the doorway, which is regularly traversed by heavy equipment like forklifts and other equipment for loading and unloading trucks arriving at the loading dock. This leads to damage of the screen assembly. Some examples of prior dock screens include:

US 2019/0390515 A1 which teaches a screen for covering a dock doorway, one that can operate independently of the dock door itself. The screen door installs on an internal side of the dock, located in the gap between the dock door and the doorway wall. When the screen door is raised, a gap between the dock door and the dock wall is present.

US 2022/0237968 A1 which teaches a dock shelter inside the frame/jamb of a dock doorway. It includes a first gate that is in communication with an outside of the dock building and a second gate that is in communication with an interior of the dock building. The first gate is not a screen per se, and it is also taught that the first gate and second gate are not opened and closed independently.

U.S. Pat. No. 3,358,865 A teaches an externally mounted shelter including a support frame having a cover piece and head curtain at the top and side curtains and supported on side walls and of the shelter. It does not appear that the shelter is retractable, but rather serves to frame the doorway and provide an extend sheltered area between the doorway and a real end of the truck to be loaded/unloaded.

### SUMMARY

A dock screen system for covering an outside face of a dock doorway opening is described. The dock screen includes a frame sized to fit around the outside face of the dock doorway and affixed to the doorway; a guide rail mounted recessed in the frame; a screen track held in the guide rail; and a screen, extendably and retractably mounted on a mounting roll to move along the screen track. In an extended position, the screen sits directly against the outside face of the doorway and eliminates any gaps through which insects or debris could enter.

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly, the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is front elevation view of a dock screen system of one embodiment of the present disclosure, with the dock screen in a lowered position;

FIG. 2 is a front elevation view of the dock screen system of FIG. 1, with the dock screen in a lowered position, with a drop curtain shown;

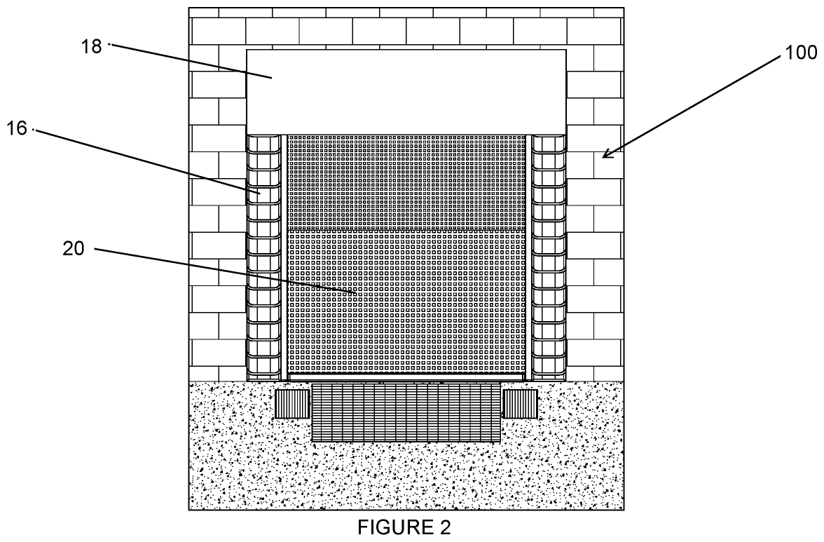

FIG. 3 is a front elevation view of a dock doorway showing the dock screen of FIG. 1 in a raised position and a dock door lowered;

FIG. 4 is a front elevation view of a dock doorway showing the drop curtain of FIG. 2 and dock seals of the present disclosure;

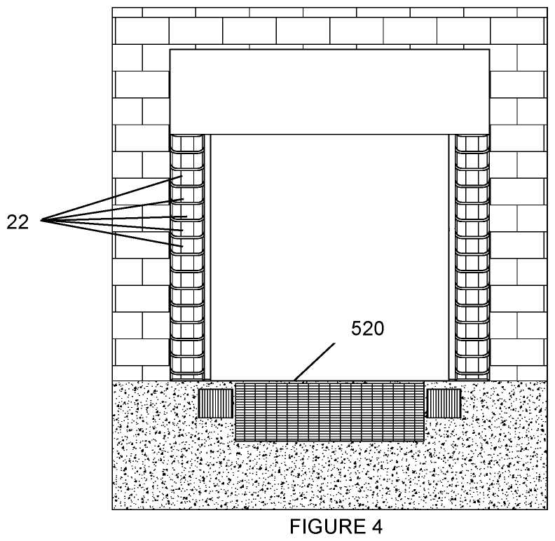

FIG. 5 is a perspective view of a dock doorway from inside of a loading dock, showing a track mounted on an outside of the dock doorway, for use with the dock screen of FIG. 1, and dock seals;

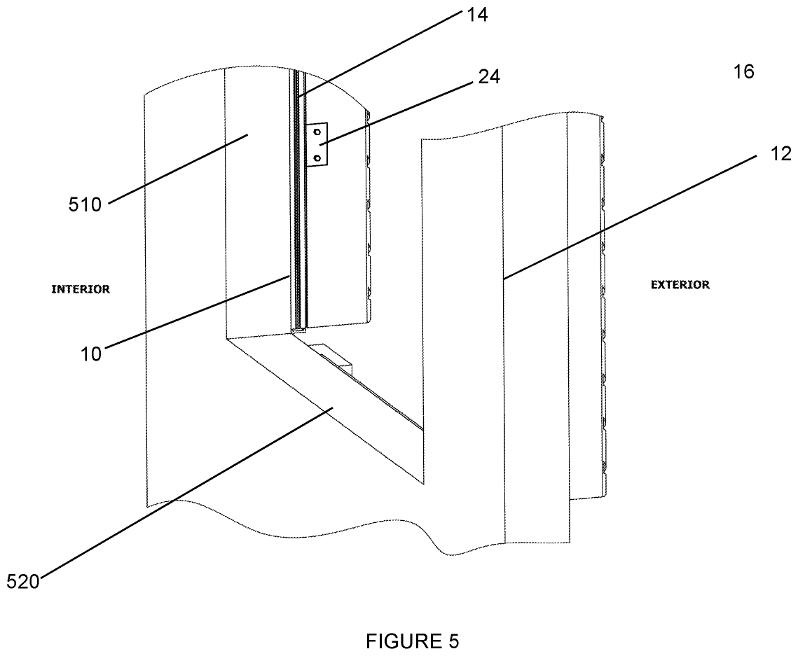

FIG. 6 is a perspective view of a dock doorway from inside of a loading dock, showing an upper section of the track of FIG. 5, mounted on an outside of the dock doorway, and showing dock seals and drop curtain;

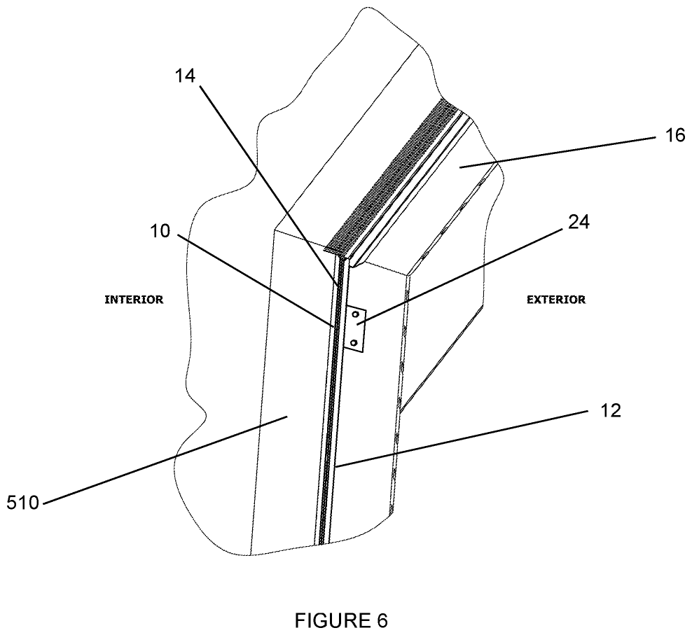

FIG. 7 is a close-up view of an example of a dock screen of the present disclosure, in a retracted and rolled up position, at an upper end of the track of FIG. 5;

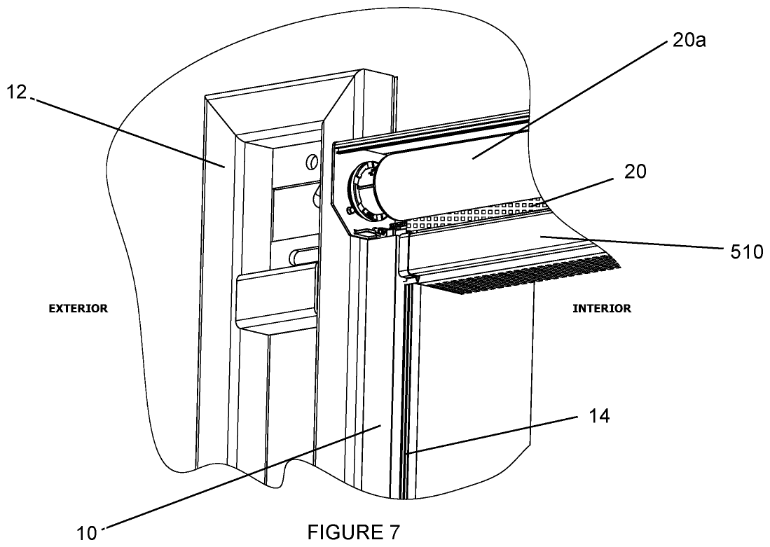

FIG. 8 is a perspective view of a dock doorway from inside of a loading dock, showing the dock screen in a partially retracted position, showing the track mounted on an outside of the dock doorway; and

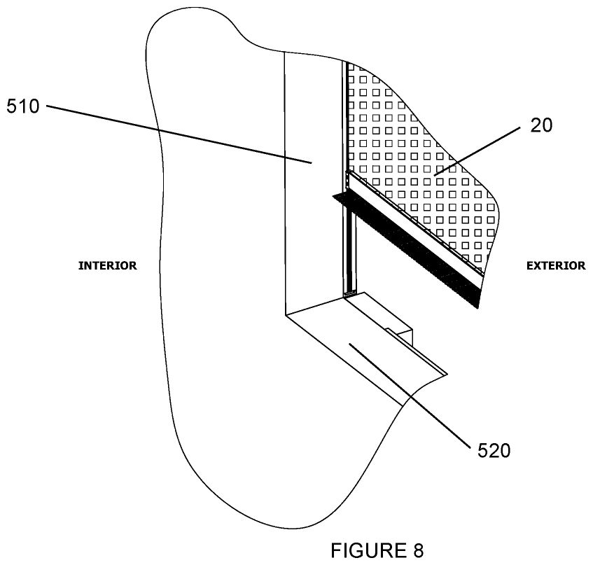

The drawings are not necessarily to scale and in some instances, proportions may have been exaggerated in order to depict certain features more clearly.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

The present disclosure provides a screen system for use with a doorway of a loading dock. The screen of the screen system allows for air circulation and venting at the loading dock doorway and into the loading building, while also preventing entry of insects, larger dirt and debris, etc. The present dock screen system is mounted to an outside of the dock doorway. The present dock screen system can be customized to be affixed to any existing or new dock door, regardless of size.

With reference to the Figures, the present disclosure proposes an externally mounted dock screen system 100 including a frame 12 sized to fit to an outer surface of the doorway 500. The frame 12 is comprised of a single, solid, steel frame. This frame 12 can be a standard unit, or built from a template or the frame 12 can be custom built to fit each door size in relation to the application. Each solid frame 12 is affixed to the outer surface of the doorway.

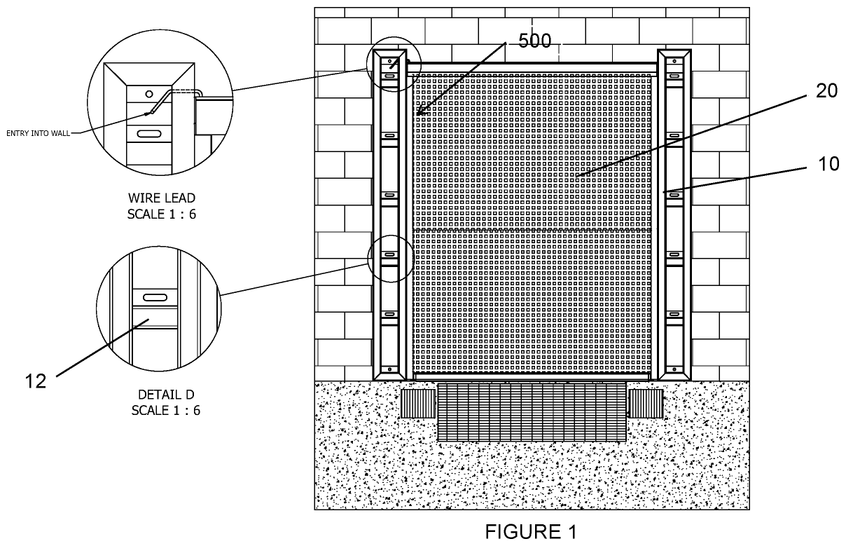

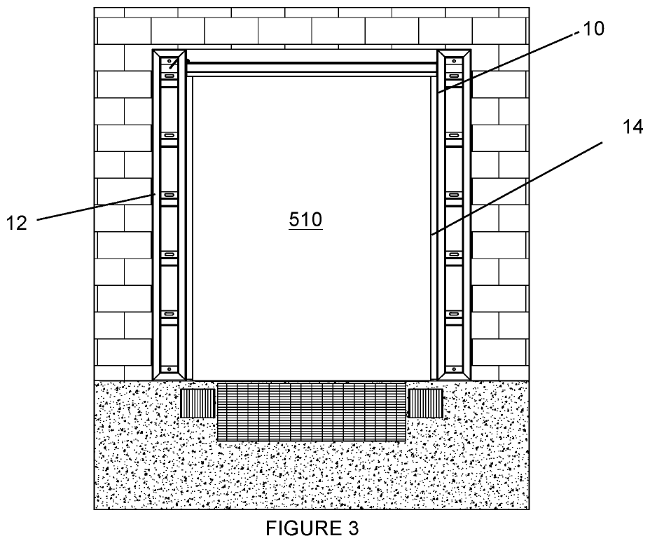

Guide rails 10 are mounted in a recessed fashion within either side of the frame 12. The guide rails 10 each support within them a screen track 14, to receive a dock screen 20. The dock screen travels along the screen track 14 from a lowered position, as illustrated in FIG. 1, to a retracted position as illustrated in FIG. 3.

The screen track 14 can be of any known style of screen track including zipper tracks, cable tracks etc. Preferably the screen track is a floating track 14 that floats within guide rail 10 and allows for some movement of the dock screen 20 and screen track 14 within guide rails 10 to accommodate expansion and contraction of the dock screen 20, as well movement of the dock screen 20 due to wind. By mounting the guide rail 10 with screen track 14 directly onto the outside of the doorway 500 via customizable frame 12, the dock screen 20, when lowered, sits flush against an external surface of the doorway 500 and eliminates any gaps through which insects or debris could enter.

The dock screen 20 may be made from fabrics with specific solar radiation reflective, absorption, and transmission values depending on climate conditions of use and need for insulation. The dock screens 20 may have specific permeabilities to allow for a desired amount of airflow through the dock screen 20. There is also the ability to change the fabric of the dock screen 20 in a particular system 100 as needed to meet designated air flow values or weather conditions.

The dock screen system 100 preferably includes independent motorization and controls that are separate to those of the dock door 510, allowing any combination of dock door 510 and dock screen 20 to be raised and/or lowered, depending on need. Preferably the dock screen system 100 includes a motor (not shown) for raising and lowering the dock screen 20, the motor being preferably located within dock screen 20 mounting roll 20a to power the rotation of roll 20a and therefore the raising and lowering of dock screen 20 along tracks 14.

A control panel (not shown) for controlling raising and lowering of the dock screen 20 can be located within the loading dock building, either just inside of the dock doorway 500 or further inside the building, preferably any location so long as the dock door system is within line of sight of the control panel.

Operation of the dock screen system 100 can be done using any well known remote transmission means including, for example but not limited to Remote Technology Somfy (RTS) or the system 100 can be hard-wired, and switch controlled from within the dock doorway. Hard-wired options allow for control unit integration and sequence controlled operation by the dock personnel. Sequence controlled operation is when the unit is wired into a docking control system. In this way, a particular sequence of operational steps that occurs when a truck is preparing to load/unload can be controlled by the control system. The docking control system will only allow certain steps to occur either (a) in a specific order/sequence or (b) only if certain constraints are met. Examples of constraints include ensuring that vehicle restraints, that lock the vehicle in position, will not engage until the vehicle is fully sealed against the doorway 500 or that the dock door 510 or dock screen 520 will not open until the vehicle restraint is engaged.

In a preferred embodiment, the docking control system may be programmed so that the dock screen 520 is lowered while the dock door 510 is opened, to ensure that something is always blocking the dock doorway 500 for safety reasons.

The docking control system may also be programmed such that the dock screen 20 can automatically be raised if the vehicle restraint is engaged and the dock screen 20 cannot be lowered while the vehicle restraint is engaged.

Remote transmission operation allows for obstacle detection and single button operation that can be placed in any ideal location. There is no extra wiring for the remote controls. Remote transmission motors are wired directly into junction boxes and can include a switch to cut power if the need arises. Motors are UL™ Component Certified and include thermal breaks that will disable the motor in case of overheating. The thermal break will reset and allow the motor to function normally once the motor is no longer overheated.

The dock screen 20 and dock door 510 are now on opposite sides of the doorway 500, allowing for repair, maintenance, or replacement of either unit to be done without interference from the other.

As well, since the dock screen system 100 is completely free of any parts connected to a floor 520 of the dock doorway 500, movement of heavy equipment across the floor 520 for loading and unloading goods do not come into contact with the dock screen system 100 and thus chances of damage are reduced.

With the dock screen 20 and the dock door 510 located on opposite sides of the doorway 500, both dock screen 20 and dock door 510 can be lowered to be flush against a respective outside or inside surface of the dock doorway 500. This prevents a gap along the dock doorway 500 on both surfaces.

The guide rail 10 and tracks 14 are further preferably protectively covered by dock seals 16. The dock seals 16 are mountable to the frame 12, such that they overlap and extend beyond the guide rail 10 and screen track 14. The dock seals 16 provide an impact bumper between any vehicles backing up to the dock doorway 500 and the equipment of the dock screen system 100. Particularly, with the dock seals being mounted to the frame 12, which is made of solid metal, impact is absorbed from the dock seals 16 into the frame 12, without being transmitted to the guide rail 10 or tracks 14 which are recessed within the frame 12.

The arrangement of the solid frame 12 and the guide rail 10 recessed into the frame 10 allows for the externally mounted dock screen system to handle potential impacts of loading vehicles without the disadvantages of internally or jamb mounted screen systems.

In addition to protecting the guide rail 10 and tracks 14, the dock seals 16 also serve a function of providing a seal between the outside of dock doorway 500 and a loading vehicle that is backed up to the dock. More preferably, the dock seals 16 are mounted to the frame 12 by means of one or more brackets 24, affixed to the frame 12 at various heights, the dock seals 16 being removably fastenable to the brackets 24.

The dock seals 16 are optionally and preferably covered by one or more wear flaps 22, to protect the dock seals 16 from friction wear and contact with the vehicle during docking.

A drop curtain 18 is also provided to cover an upper end of the dock doorway 500 and to cover the dock screen 20 mounting roll 20a, motor and other hardware of the dock screen system 100 that are located at the upper end of the dock doorway 500. The drop curtain 18 prevents dust and precipitation from falling on the dock screen mount roll 20a and other hardware located at the upper end of the dock doorway 500. The drop curtain 18 also serves to seal any gap between the top of a loading vehicle and the top of the dock doorway 500.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A dock screen system for covering an outside face of a dock doorway opening, said dock screen comprising:
a. a frame sized to fit around the outside face of the dock doorway and affixed to the doorway;
b. a guide rail mounted recessed in the frame;
c. a screen track held in the guide rail; and
d. a screen, extendably and retractably mounted on a mounting roll to move along the screen track,
such that, in an extended position, the screen sits directly against the outside face of the doorway and eliminates any gaps through which insects or debris could enter.

2. The dock screen system of claim 1, wherein the frame is comprised of a single, solid, frame sized to fit the outside face of the dock doorway.

3. The dock screen system of claim 1, further comprising a drop curtain mounted to an upper end of the guide rail to provided to cover the dock screen mounting roll and any hardware of the dock screen system that are located at an upper end of the dock doorway, and to seal any gap between a top of a loading vehicle that is backed up to the dock, and the upper end of the dock doorway.

4. The dock screen system of claim 1, further comprising dock seals, mountable to the frame such that they overlap and extend beyond the screen track and guide rail to protect the guide rail and screen track, to provide an impact bumper and seal between the outside face of the dock doorway and a loading vehicle that is backed up to the dock.

5. The dock screen system of claim 4 wherein the dock seals transmit any impact from the loading vehicle to the frame.

6. The dock screen system of claim 1, further comprising an independent motor and control system separate to any motorization or control of a dock door, allowing any combination of dock door and dock screen to be raised and lowered independently.

7. The dock screen system of claim 6, wherein the control system comprise a remote transmission system including a remote control and wherein the motor is wired directly into a junction box at the dock doorway.

8. The dock screen system of claim 7, wherein the control system comprises a hard-wired system with a local switch located on the outside face or an inside face of the dock doorway.

9. The dock screen system of claim 8, wherein the motor includes thermal breaks to disable the motor in case of overheating.

10. The dock screen system of claim 1, wherein the screen track is a floating track that floats within the guide rail, supported by pads, and allows for movement of the dock screen and screen track within the guide rail, to accommodate expansion and contraction of the dock screen or due to wind.
